(19) United States
(12) Patent Application Publication
(10) Pub. No.: US 2021/0104237 A1
(43) Pub. Date: Apr. 8, 2021

(54) Method and Apparatus for Providing Modular Speech Input to Client Applications

(71) Applicant: Zebra Technologies Corporation, Lincolnshire, IL (US)

(72) Inventors: Ying Wu, Oakville (CA); Jocelyn C. Visco, Toronto (CA); Noel Steven Massey, Carpentersville, IL (US)

(21) Appl. No.: 16/596,715

(22) Filed: Oct. 8, 2019

(51) Int. Cl. G10L 15/22; G10L 15/28; G10L 15/04; G10L 15/01; G06K 7/14; G06F 3/16

(52) U.S. Cl. CPC G10L 15/22; G10L 15/28; G10L 15/04; G10L 2015/223; G06K 7/1413; G06F 3/167; G10L 15/01

(57) ABSTRACT

A computing device with an output assembly and microphone stores: an input mechanism identifier corresponding to a client application and indicating one of several input mechanisms; and speech recognition engine interfaces, executable independently of the client application to control respective speech recognition engines. The device executes the client application to generate a request for input data; responsive to the request generation, retrieves the input mechanism identifier; when the input mechanism identifier indicates a predetermined engine, provides the request to a corresponding speech recognition engine interface; executes the corresponding interface to control the predetermined engine to obtain audio data via the microphone, for conversion of the audio data to input data by the predetermined engine; receives the input data at the corresponding interface from the predetermined engine; returns the input data to the client application; and executes the client application to control the output assembly to present the input data.

### BACKGROUND

Data capture devices are used in a wide variety of environments, such as warehouses, manufacturing facilities, retail facilities, healthcare institutions, and the like. In such environments, a data capture device may be employed to capture data from objects, such as serial numbers displayed on packages in a warehouse facility, and to process the captured data (e.g. to send the data to a server) using a client application running on the data capture device.

Different input mechanisms may be employed by the data capture device, including a speech recognition mechanism. However, certain input mechanisms may be poorly suited to certain operating environments, and altering an application to accommodate a different input mechanism can be costly and time-consuming.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a data capture device.

FIG. 2 is a flowchart of a method for providing modular speech input to client applications.

FIG. 3 is a diagram illustrating an input interface rendered by the device of FIG. 1.

FIG. 4 is a block diagram of certain internal components of the data capture device of FIG. 1.

FIG. 5 is a diagram illustrating the input interface of FIG. 3 following a performance of the method of FIG. 2.

FIG. 6 is a block diagram of certain internal components of the data capture device of FIG. 1 in another embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method of providing input data to client applications in a computing device, the method comprising: storing, in a memory of the computing device: (i) an input profile containing an input mechanism identifier corresponding to a client application, the input mechanism identifier indicating one of a plurality of input mechanisms; and (ii) a set of speech recognition engine interfaces, executable independently of the client application and configured to control respective speech recognition engines; via execution of the client application at a processor of the computing device, generating a request for input data; responsive to generation of the request for input data, retrieving the input mechanism identifier from the input profile; responsive to determining that the input mechanism identifier indicates a predetermined speech recognition engine, providing the request for input data to a corresponding speech recognition engine interface among the set of speech recognition engine interfaces; via execution of the corresponding speech recognition engine interface, controlling the predetermined speech recognition engine to obtain audio data via a microphone for conversion of the audio data to input data by the predetermined speech recognition engine; receiving the input data at the corresponding speech recognition engine interface from the predetermined speech recognition engine; returning the input data to the client application; and via execution of the client application, controlling an output assembly of the computing device to present the input data.

Additional examples disclosed herein are directed to a computing device, comprising: an output assembly; a microphone; a memory storing: (i) an input profile containing an input mechanism identifier corresponding to a client application, the input mechanism identifier indicating one of a plurality of input mechanisms; and (ii) a set of speech recognition engine interfaces, executable independently of the client application and configured to control respective speech recognition engines; a processor interconnected with the memory and the microphone, the processor configured to: execute the client application to generate a request for input data; responsive to generation of the request for input data, retrieve the input mechanism identifier from the input profile; responsive to determining that the input mechanism identifier indicates a predetermined speech recognition engine, provide the request for input data to a corresponding speech recognition engine interface among the set of speech recognition engine interfaces; execute the corresponding speech recognition engine interface to control the predetermined speech recognition engine to obtain audio data via the microphone, for conversion of the audio data to input data by the predetermined speech recognition engine; receive the input data at the corresponding speech recognition engine interface from the predetermined speech recognition engine; return the input data to the client application; and execute the client application to control the output assembly to present the input data.

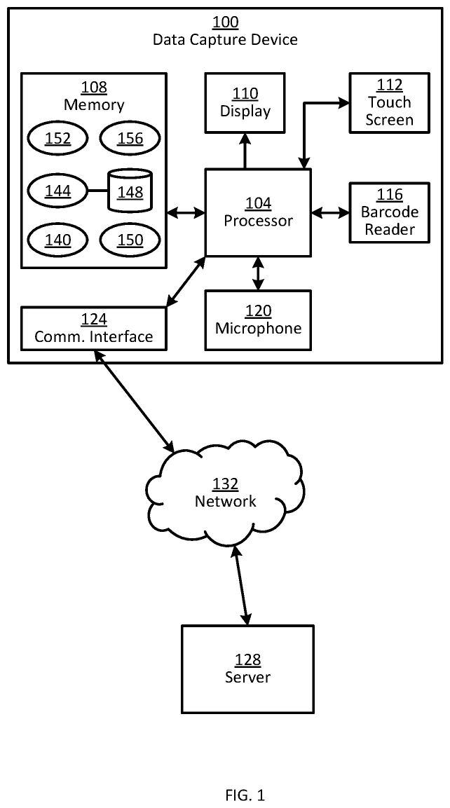

FIG. 1 depicts an example data capture device 100 in accordance with the teachings of this disclosure. The data capture device 100 includes a central processing unit (CPU), also referred to as a processor 104, interconnected with a non-transitory computer readable storage medium, such as a memory 108. The memory 108 includes any suitable combination of volatile memory (e.g. Random Access Memory (“RAM”)) and non-volatile memory (e.g. read only memory (“ROM”), Electrically Erasable Programmable Read Only Memory (“EEPROM”), flash memory). In general, the processor 104 and the memory 108 each comprise one or more integrated circuits.

The data capture device 100 also includes a display 110 (e.g. an active-matrix OLED, or AMOLED, display or the like). The display 110 is configured to receive data from the processor 104 and to render or otherwise present the data to an operator of the data capture device 100. In other examples, the data capture device 100 can include additional output assemblies in addition to the display 110, such as one or more of a speaker, indicator light, and the like.

The data presented by the output assemblies of the device 100, such as the display 110, can include data stored in the memory 108 (certain aspects of which will be discussed below in greater detail). The data presented by the output assemblies can also include input data captured by the device 100, e.g. from the operator of the device 100, via various input mechanisms. As will be discussed below, examples of the input mechanisms include barcode scanning, as well as one or more speech recognition mechanisms that enable the device 100 to convert speech (e.g. of the operator) to text.

To that end, the data capture device 100 further includes a plurality of input assemblies, each including a suitable combination of hardware elements and associated microcontrollers, firmware and the like for obtaining input data and providing the input data to the processor 104. The nature of the input data obtained varies for each input assembly. In the present example, three input assemblies are illustrated. In particular, the input assemblies include a touch screen 112 configured to receive touch input. The touch screen 112 can be integrated with the display 110. The input assemblies of the data capture device 100 also include a barcode reader 116 controllable to capture barcodes. The barcode reader 116 includes any suitable one of, or any suitable combination of, imaging sensors, light emitters (e.g. laser emitters), reflectors and the like enabling the barcode reader 116 to capture and decode barcodes.

The input assemblies of the data capture device 100 also include a microphone 120, configured to capture audio for provision to the processor 104 and conversion to strings of characters. The conversion of speech captured via the microphone 120 to text includes the execution, by the processor 104, of specialized software modules to be discussed in greater detail below. Various such modules may be employed by the device 100, and the device 100 includes additional features that enable various client applications to make use of such modules in a modular manner. In other words, the microphone 120 enables a plurality of distinct input mechanisms, which may be interchangeably controlled to obtain input data for client applications on the device 100.

The barcode reader 116 and the microphone 120 may be integrated with the data capture device 100 (e.g. contained in a housing of the data capture device 100), or deployed as separate devices with wired or wireless connections to the data capture device 100.

The data capture device 100 also includes a communications interface 124 interconnected with the processor 104. The communications interface 124 includes any suitable components (e.g. transmitters, receivers, network interface controllers and the like) allowing the data capture device 100 to communicate with other computing devices such as a server 128, either directly or via a network 132 (e.g. a local or wide-area network, or a combination thereof). The specific components of the communications interface 124 are selected based on the type of network or other communication links that the data capture device 100 is required to communicate over.

The various components of the data capture device 100 are interconnected, for example via one or more communication buses. The device 100 also includes a power source for supplying the above-mentioned components with electrical power. In the present example, the power source includes a battery; in other examples, the power source includes a wired connection to a wall outlet or other external power source in addition to or instead of the battery. The data capture device 100 also includes a housing supporting the components mentioned above. In some examples, the housing is a unitary structure supporting all other components of the data capture device 100. In other examples, the housing is implemented as two or more distinct (e.g. separable) housing components, such as a first component comprising a pistol-grip handle including a cradle configured to receive a second component comprising the housing of a smartphone, tablet computer, or the like.

The memory 108 stores one or more applications, each including a plurality of computer readable instructions executable by the processor 104. The execution of the above-mentioned instructions by the processor 104 causes the data capture device 100 to implement certain functionality discussed herein. In the discussion below, the applications are said to be configured to perform various functionality. It will be understood that the performance of such functionality is enabled by the execution of the relevant application at the processor 104.

In particular, the memory 108 stores an operating system 140 that, as will be apparent to those skilled in the art, includes instructions (e.g. device drivers and the like) executable by the processor 104 for interoperating with the other components of the data capture device 100, including the input assemblies mentioned above. The memory 108 also stores an input service application 144 (also simply referred to below as the input service 144) and an associated input profile repository 148, which will be discussed in greater detail below.

The memory 108 further stores a speech recognition engine 150, which is a specialized software module executable by the processor 104 to convert audio captured via the microphone 120 into strings of characters. Although a single speech recognition engine 150 is shown in FIG. 1, in other examples the memory 108 can store a plurality of speech recognition engines.

In addition, the memory 108 stores at least one client application. In the present example, two client applications 152 and 156 are illustrated. As will be apparent to those skilled in the art, in other embodiments the data capture device 100 may store only one client application, while in further embodiments the data capture device 100 may store a greater number of client applications than the two illustrated.

The client applications 152 and 156, when executed by the processor 104, implement any of a variety of functionality desired by an entity operating the data capture device 100. For example, the data capture device 100 can be deployed in a warehouse facility and the application 152 can configure the data capture device 100 to capture data associated with objects (e.g. packages) in the warehouse and provide such data to the server 132.

In general, each of the client applications 152 and 156 stored in the memory 108 is configured to prompt an operator of the data capture device 100 for input data, for example by rendering one or more input fields on the display 110. As noted above, various input mechanisms can be employed to populate such fields. In some deployments, e.g. when the operator of the device 100 operates the device in a hands-free mode, a speech-based input mechanism may be employed. At different times, or in different facilities, however, the most suitable input mechanism may barcode scanning rather than speech input. Still further, different deployment environments may render one speech recognition engine more or less suitable than another. Thus, it may be desirable to deploy the client application 152 on devices 100 at a first facility in order to obtain speech-based input via the speech recognition engine 150, and to deploy the same client application 152 on other devices 100 at a second facility in order to obtain speech-based input via a different speech recognition engine. Different speech recognition engines may have performance characteristics (e.g. accuracy in noisy environments) that render them more or less suitable under different conditions.

Speech recognition engines such as the speech recognition engine 150 may be provided by distinct vendors, and may also expose distinct application programming interfaces (APIs), input data formats, and the like. Obtaining input data for the client applications 152 and 156 via different input mechanisms, and particularly via different speech-based input mechanisms, may therefore be complicated by the distinct requirements of each input mechanism.

To mitigate the need to deploy different versions of the applications 152 and/or 156, as well as the need to implement compatibility with numerous speech recognition vendor-specific APIs within the applications 152 and/or 156 to enable use of any available speech recognition engines by the applications 152 and 156, the input service 144 configures the processor 104 to select an appropriate input mechanism, and to control the selected input mechanism and return input data to the client applications 152 and/or 156. The client applications 152 and 156 themselves are therefore not required to be configured to directly control input mechanisms such as the speech recognition engine 150 to obtain input data. As a result, the client applications 152 and 156 can be deployed to the data capture device 100 independently (i.e. earlier than, or later than) the input service 144. Further, the input service 144 can be updated, e.g. to enable the use of additional input mechanisms, after deployment of the client applications 152 and 156, without requiring changes to the client applications 152 and 156.

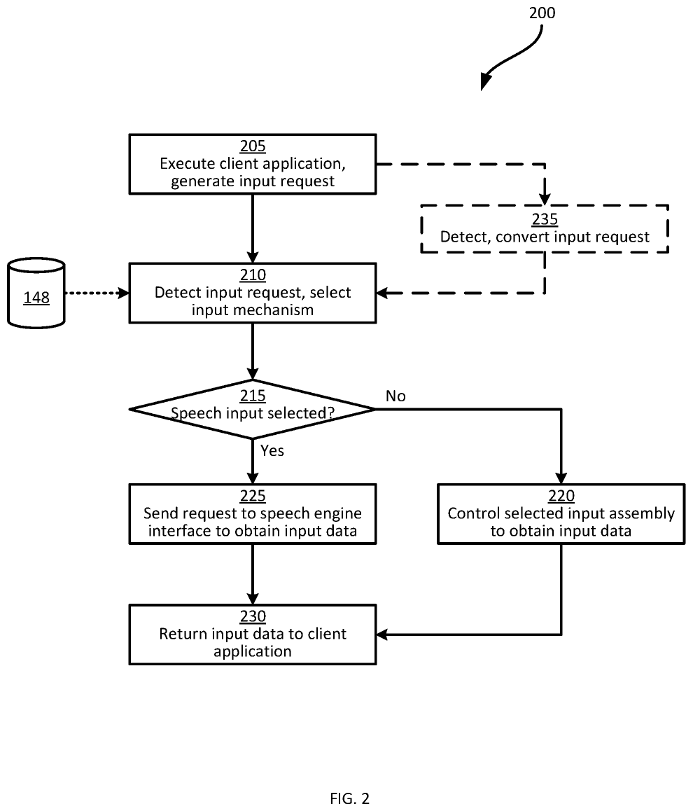

Turning now to FIG. 2, a method 200 of providing modular speech input to client applications is illustrated. The method 200 will be described in conjunction with its performance on the data capture device 100 as illustrated in FIG. 1.

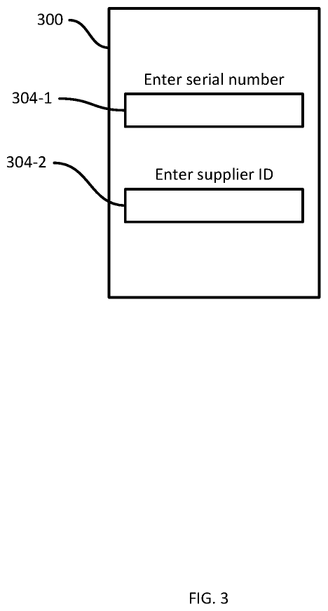

At block 205, a client application is configured to generate a request for input data (also referred to herein as an input request). For example, the client application 152 can define one or more input fields, and can be configured to render the input fields on the display 110. Turning briefly to FIG. 3, an example interface 300 defined by the client application 152 is illustrated as presented on the display 110 responsive to execution of the client application 152 by the processor 104. The interface 300 includes first and second input fields 304-1 and 304-2, respectively. As indicated by the descriptive text of the interface 300, the first field 304-1 prompts the operator of the data capture device 100 to enter a serial number (e.g. of a product), and the second field 304-2 prompts the operator to enter a supplier identifier corresponding, for example, to a manufacturer of the product.

The request for input data at block 205 is generated by the client application 152 responsive to one of the fields 304 shown in FIG. 3 receiving focus (i.e. being selected to receive input, either automatically by the client application 152, or by the operator of the device 100). Responsive to detecting that one of the input fields 304 has received focus, the client application 152 generates a request for input data, which is processed by the input service 144 as set out below.

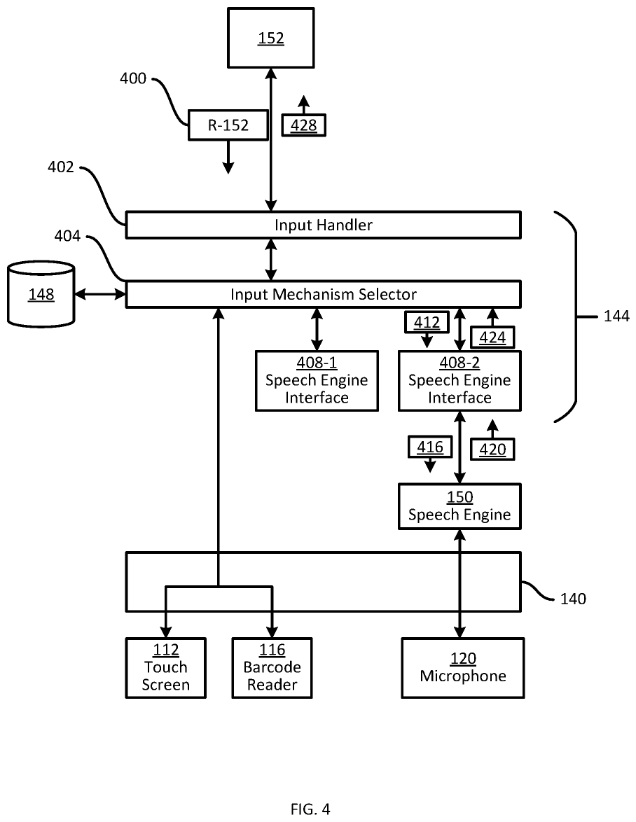

Returning to FIG. 2, at block 210, the input service 144 (which is executed by the processor 104 simultaneously with the client application 152) is configured to detect the above-mentioned input request from the client application 152, and to select an input mechanism with which to obtain input data to respond to the input request. In other words, the client application 152 itself need not specify which input mechanism is to be used to obtain input data to populate the fields 304. As will be discussed below in connection with FIG. 4, selection of an input mechanism is performed by the input service 144 with reference to the input profile repository 148.

Referring to FIG. 4, a schematic diagram illustrates interactions between the client application 152 and components of the input service 144, as well as interactions between the input service 144 and input mechanisms (e.g. the input assemblies 112 and 116, or the microphone 120 and the speech recognition engine 150) during the performance of the method 200.

As shown in FIG. 4, the input service 144 and the operating system 140 intermediate between input mechanisms and the client application 152 (as well as the client application 156, not shown in FIG. 4 for simplicity). The client application 152, as noted above, is therefore not required to include executable instructions for interacting with any specific input mechanism. In addition, the input request 400 generated at block 205 need not specifically identify any particular input mechanism. Instead, the client application 152 need only invoke a component of the input service 144. The input service 144 itself is configured to select an appropriate input mechanism based on the identity of the client application 152 and the contents of the input profile repository 148. The input service 144 further includes components (i.e. further executable instructions) for interacting with the input assemblies 112, 116 via the operating system 140, and for interacting with the input assembly 120 (i.e. the microphone 120) via the operating system 140 and the speech recognition engine 150.

The input service 144 includes an input handler 402 configured to receive the input request 400, and to return input data to the client application 152, for populating the active field 304. The input handler 402 may, for example, define one or more soft keyboards for rendering on the display 110 to receive input data in the form of key selections. The input handler 402 can therefore return input data as keystrokes to the client application 152, regardless of the origin of the input data (i.e. whether the input data was typed, decoded from a barcode, or spoken by the operator of the device 100).

The input handler 402 is configured, at block 210, to pass an identifier of the client application 152 contained in the request 400 to an input mechanism selector 404 of the input service 144. The client application identifier passed to the input mechanism selector 404, in the present example, is the reference numeral “152”. A wide variety of other client application identifiers may be employed, however. The input mechanism selector 404 is configured to receive the above-mentioned client application identifier from the input handler 402, and to select, based on the client application identifier and the input profile repository 148, a specific input mechanism to control for obtaining input data in response to the input request 400. Input data obtained via the selected input mechanism is returned to the input handler 402, for delivery to the client application 152.

Having received the client application identifier, the input mechanism selector 404 retrieves an input profile from the repository 148. The repository 148 contains a plurality of profiles, each identifying one or more client applications, and each indicating which input mechanism is to be employed to obtain input data for the identified client applications. Table 1, below, contains two example profiles in the input profile repository 148.

TABLE 1
Example Input Profile Repository 148

| Profile ID | Client App ID | Input Mechanism | Parameters |
|---|---|---|---|
| VoiceProfile1 | 152 | Speech Engine 150 | |
| BarcodeProfile1 | 156 | 116 | QR; PDF417 |

As seen in Table 1, a first profile, named “VoiceProfile1”, identifies the client application 152 and indicates that the speech recognition engine 150 is the input mechanism to be employed in obtaining input data for the client application 152. A second profile named “BarcodeProfile1” identifies the client application 156, and indicates that the input assembly 116 (i.e. the barcode scanner 116) is the input mechanism to be employed in obtaining input data for the client application 156. The second profile also includes configuration parameters for the barcode scanner 116, such as identifiers of barcode symbologies to be returned by the barcode scanner 116.

Although not shown in Table 1, the first profile can also include configuration parameters for the speech recognition engine 150. Examples of such configuration parameters include trigger settings (e.g. which commands from the operator of the device 100 begin and end recording of audio via the microphone 120 for speech recognition). Another example of such configuration parameters includes grammatical criteria, such as an indication that only numbers are to be recognized from recorded audio.

At block 210, therefore, the input mechanism selector 404 selects which input mechanism to control for obtaining input data in response to the request from block 205. In the present example, according to Table 1, the speech engine 150 is selected at block 210. Returning to FIG. 2, at block 215 the input mechanism selector 404 is configured to determine whether the selected input mechanism is a speech recognition engine. When the determination is negative, the performance of the method 200 proceeds to block 220, at which the input selector mechanism 404 is configured to control the selected input assembly, such as the barcode scanner 116, to obtain input data. When the determination at block 215 is affirmative, however, the input mechanism selector 404 is configured to interact with an additional component of the input service 144, which enables the device 100 to provide modular speech-based input to client applications from multiple speech engines, while minimizing modifications to client applications to make use of such speech engines.

Specifically, at block 225 the input mechanism selector 404 is configured to send the input request to a speech recognition engine interface to obtain input data. Turning to FIG. 4, the input service 144 includes two speech recognition engine interfaces 408-1 and 408-2. Each speech recognition engine interface 408 is configured to intermediate between the input mechanism selector 404 and a corresponding speech recognition engine. As illustrated in FIG. 4, the speech recognition engine interface 408-2 is configured to intermediate between the input mechanism selector 404 and the speech recognition engine 150. The speech recognition engine interface 408-1 is configured to interface with another speech recognition engine that is not present (i.e. is not installed on the device 100). The speech recognition engine interface 408-1 may therefore be considered inactive in the illustrated example.

Each speech recognition engine interface 408 is configured to control a specific one of the available speech recognition engines. Thus, the speech recognition engine interface 408-2 includes a mapping between a request format employed by the input handler 402 and input mechanism selector 404, and a request format employed by the speech recognition engine 150. The request format employed by the speech recognition engine 150 can be defined by an API exposed by the speech recognition engine 150, and the speech recognition engine interface 408-2 therefore maps commands and other parameters in the above-mentioned API to commands native to the input mechanism selector 404 and the input handler 402.

At block 225, therefore, the input mechanism selector 404 is configured to send an input request 412 to the speech recognition engine interface 408-2. The request 412 can include any configuration parameters mentioned above from the profile repository 148. In turn, the speech recognition engine interface 408-2 is configured to convert the input request into a request 416 in the format native to the speech recognition engine 150, and to thereby control the speech recognition engine 150 to obtain, via interaction with the microphone 120 through the operating system 140, input data in the form of a string of characters derived from recorded audio.

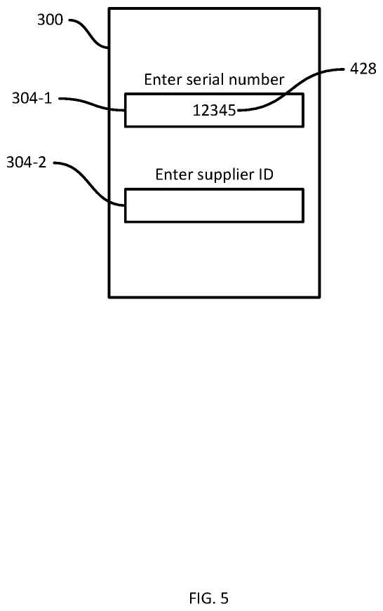

Input data 420 obtained by the speech recognition engine 150 is returned to the speech recognition engine interface 408-2, where the input data 420 may be converted into the format native to the input mechanism selector 404 and input handler 402. The converted input data 424 is provided to the input mechanism selector 404. The input data 424 may be further manipulated at the input service, according to processing rules in the profile 148. Such processing rules can include, for example, appending specific characters (e.g. a tab character) to the input data. The manipulated input data 428 is then returned to the client application 152 at block 230, and may be rendered on the display 110 as shown in FIG. 5. In other examples, the input data 428 can be played back (via text-to-speech) by a speaker, transmitted to another computing device via the communications interface 124 or the like. More generally, an output assembly of the device 100 (e.g. the display 110, the above-mentioned speaker, the communications interface 124, or a combination thereof) can be controlled via execution of the client application 152 or 156 to output and/or transmit the input data 428. That is, the client applications 152 or 156 process the input data, and in addition to the above-mentioned presentation of the input data, can initiate further actions using the input data, e.g. to generate a prompt for further input data, manipulate and/or store the input data, and the like.

As will now be apparent to those skilled in the art, the inclusion of multiple speech recognition engine interfaces 408 enables the deployment of alternative, or additional, speech recognition engines at the device 100. Enabling the use of such other speech recognition engines to provide speech-based input to the client applications 152 and 156, even after deployment of the client applications 152 and 156, requires only updates to the profile repository 148, and installation of the speech recognition engines themselves. Modifications to the client applications 152 and 156 themselves may be minimized or avoided entirely.

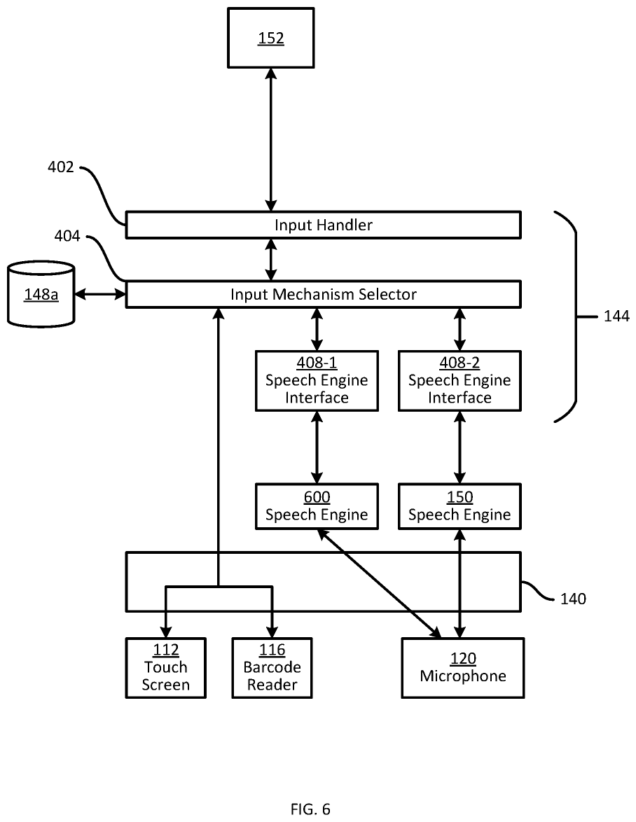

Turning to FIG. 6, the architecture shown in FIG. 4 is reproduced, with an additional speech recognition engine 600 installed (i.e. stored in the memory 108 for execution by the processor 104). The input profile repository 148 is replaced by an updated input profile repository 148a, example contents of which are shown below in Table 2.

TABLE 2
Example Input Profile Repository 148a

| Profile ID | Client App ID | Input Mechanism | Parameters |
|---|---|---|---|
| VoiceProfile1 | 152 | Speech Engine 600 | |
| BarcodeProfile1 | 156 | 116 | QR; PDF417 |

Updating the input profile repository 148 or 148a can be accomplished via an administrative process, such as a staging application executed by the processor 104 and configured to retrieve input profiles from the server 128 or other computing device. As seen above, the profile “VoiceProfile1” has been updated to indicate the use of the speech recognition engine 600 rather than the speech recognition engine 150. As seen in FIG. 6, the speech recognition engine interface 408-1 already included in the input server 144 is configured to interface with the speech engine 600. Thus, no further modifications are required to enable the client application 152 to obtain input via the speech recognition engine 600. As will now be apparent, difference input profiles can make use of either of the installed speech recognition engines 150 and 600. Alternatively, the speech recognition engine 150 may be removed (i.e. uninstalled) from the device 100, leaving the speech recognition engine interface 408-2 inactive.

In further examples, the set of speech recognition engines with which the input service 144 is enabled to interact can be expanded by updating the input service 144 to include additional speech recognition engine interfaces 408, regardless of whether the corresponding speech recognition engines themselves are present on the device 100. As noted earlier in connection with the profile repository 148, updates to the input service 144 to include additional speech recognition engine interfaces 408 can be performed either before or after deployment of the client applications 152 and 156, minimizing or avoiding updates to the client applications 152 and 156 themselves.

Although the speech recognition engines 150 and 600 discussed above are stored at the device 100 itself, in other examples one or more speech recognition engines can be employed by the device 100 without being stored in the memory 108. For example, the data capture device 100 can be configured to transmit data captured via the microphone 120 to a server executing a speech recognition engine, and to receive processed data from the server. In such examples, the device 100 stores a speech recognition engine interface 408 corresponding to the server-based speech recognition engine, but does not store the speech recognition engine itself. Instead, the profile repository 148 may contain a configuration parameter indicating a network address of the server.

Returning to FIG. 2, in some examples the client application 152 may generate input requests in a format that is not native to the input handler 402. For example, the client application 152 can be a browser-based application, and the input request 400 may therefore be generated in a browser-specific format, such as the W3C Speech API. In such examples, at block 235 the input handler 402 can be configured to convert the input request to a format native to the input service 144.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of providing input data to client applications in a computing device, the method comprising:
storing, in a memory of the computing device:
(i) an input profile containing an input mechanism identifier corresponding to a client application, the input mechanism identifier indicating one of a plurality of input mechanisms; and
(ii) a set of speech recognition engine interfaces, executable independently of the client application and configured to control respective speech recognition engines;
via execution of the client application at a processor of the computing device, generating a request for input data;
responsive to generation of the request for input data, retrieving the input mechanism identifier from the input profile;
responsive to determining that the input mechanism identifier indicates a predetermined speech recognition engine, providing the request for input data to a corresponding speech recognition engine interface among the set of speech recognition engine interfaces;
via execution of the corresponding speech recognition engine interface, controlling the predetermined speech recognition engine to obtain audio data via a microphone for conversion of the audio data to input data by the predetermined speech recognition engine;
receiving the input data at the corresponding speech recognition engine interface from the predetermined speech recognition engine;
returning the input data to the client application; and
via execution of the client application, controlling an output assembly of the computing device to present the input data.

2. The method of claim 1, wherein retrieving the input mechanism identifier, providing the request for input data to the corresponding speech recognition engine interface, receiving the input data and returning the input data are performed via execution of an input service simultaneously with the client application.

3. The method of claim 1, wherein controlling the predetermined speech recognition engine includes executing the corresponding speech recognition interface to convert the input request into a format native to the predetermined speech recognition engine.

4. The method of claim 1, wherein the input mechanism identifier corresponds to one of the speech recognition engines, or to a barcode scanner.

5. The method of claim 1, further comprising: storing, in the memory, a subset of the speech recognition engines, the subset being smaller than the set of speech recognition engine interfaces.

6. The method of claim 1, wherein the input profile further includes configuration parameters for the indicated input mechanism; and
wherein the method further comprises providing the configuration parameters to the speech recognition engine interface.

7. The method of claim 1, further comprising:
receiving and storing, in the memory, an additional speech recognition engine corresponding to one of the speech recognition engine interfaces.

8. The method of claim 7, further comprising:
receiving and storing, in the memory, an updated input profile containing an updated input mechanism identifier corresponding to the additional speech recognition engine.

9. The method of claim 1, further comprising: prior to retrieving the input mechanism identifier from the input profile, converting the request for input data from a client application format to a native format.

10. A computing device, comprising:
an output assembly;
a microphone;
a memory storing:
(i) an input profile containing an input mechanism identifier corresponding to a client application, the input mechanism identifier indicating one of a plurality of input mechanisms; and
(ii) a set of speech recognition engine interfaces, executable independently of the client application and configured to control respective speech recognition engines;
a processor interconnected with the memory and the microphone, the processor configured to:
execute the client application to generate a request for input data;
responsive to generation of the request for input data, retrieve the input mechanism identifier from the input profile;
responsive to determining that the input mechanism identifier indicates a predetermined speech recognition engine, provide the request for input data to a corresponding speech recognition engine interface among the set of speech recognition engine interfaces;
execute the corresponding speech recognition engine interface to control the predetermined speech recognition engine to obtain audio data via the microphone, for conversion of the audio data to input data by the predetermined speech recognition engine;
receive the input data at the corresponding speech recognition engine interface from the predetermined speech recognition engine;
return the input data to the client application; and
execute the client application to control the output assembly to present the input data.

11. The computing device of claim 10, wherein the processor is configured to retrieve the input mechanism identifier, provide the request for input data to the corresponding speech recognition engine interface, receive the input data and return the input data via execution of an input service simultaneously with the client application.

12. The computing device of claim 10, wherein the processor is configured to control the predetermined speech recognition engine by executing the corresponding speech recognition interface to convert the input request into a format native to the predetermined speech recognition engine.

13. The computing device of claim 10, further comprising an input assembly including a barcode scanner, and wherein the input mechanism identifier corresponds to one of the speech recognition engines, or to the barcode scanner.

14. The computing device of claim 10, wherein the memory further stores a subset of the speech recognition engines, the subset being smaller than the set of speech recognition engine interfaces.

15. The computing device of claim 10, wherein the input profile further includes configuration parameters for the indicated input mechanism; and
wherein the processor is further configured to provide the configuration parameters to the speech recognition engine interface.

16. The computing device of claim 10, wherein the processor is further configured to receive and store, in the memory, an additional speech recognition engine corresponding to one of the speech recognition engine interfaces.

17. The computing device of claim 16, wherein the processor is further configured to receive and store, in the memory, an updated input profile containing an updated input mechanism identifier corresponding to the additional speech recognition engine.

18. The computing device of claim 10, wherein the processor is further configured, prior to retrieving the input mechanism identifier from the input profile, to convert the request for input data from a client application format to a native format.
